(19) United States
(12) Patent Application Publication
(10) Pub. No.: US 2011/0320952 A1
(43) Pub. Date: Dec. 29, 2011

(54) NETWORK DEVICE CAPABLE OF EDITING AND CONFIGURING SETTING INFORMATION, DEVICE CONTROLLER, NETWORK SYSTEM, AND STORAGE MEDIUM

(75) Inventor: Junnosuke KATAOKA, Yokohama-shi (JP)

(73) Assignee: CANON KABUSHIKI KAISHA, Tokyo (JP)

(21) Appl. No.: 13/164,818

(22) Filed: Jun. 21, 2011

(30) Foreign Application Priority Data
Jun. 23, 2010 (JP) 2010-142687(PAT.)

(51) Int. Cl. G06F 15/177; G06F 3/048

(52) U.S. Cl. 715/735; 709/221

(57) ABSTRACT

A network system enables a common setting information item and different setting information items on a plurality of network devices to be displayed, and collectively configured and edited on a Web browser on a PC. The device controller accesses a network device to acquire and display setting information on network devices. The accessed network device collects setting information from the other network devices via a network in response to the access from the device controller, generates one HTML file based on the collected setting information, and transmits the HTML file to the device controller. The setting information configured or edited on the device controller is broken up into respective sets of setting information on the network devices, and is transmitted to the other network devices as HTML files, to cause the setting information to be reflected thereon.

### BACKGROUND OF THE INVENTION

1. Field of the Invention

The present invention relates to a network device that is connected to a network for communication with other network devices, a device controller, and a network system including the network devices and the device controller, and a storage medium.

2. Description of the Related Art

In image processing apparatuses, such as a copying machine and a facsimile machine, a user configures various settings thereof by operating an operation panel or the like provided on a main unit of the apparatus. On the other hand, some of image processing apparatuses that can be connected to computers (PC) via a network have a remote user interface (hereinafter referred to as the “RUI”) function that makes it possible to configure various settings of the image processing apparatus from a screen displayed by a Web browser on a PC. For example, in an image processing apparatus which has a Web server function incorporated, information is displayed on the Web browser using this function.

In an image processing apparatus which does not have a Web server function, there has been proposed a technique that collects MIB (management information base) information using an SNMP (simple network management protocol), and displays the information on a Web browser (see e.g. Japanese Patent Laid-Open Publication No. 2003-330824).

Further, in recent years, there have been widely spread a method and a system using the RUI function for collectively editing various items of setting information of a plurality of network devices connected to a network. For example, by collectively managing users' access rights to network resources using a directory service, it is possible to enable each user to access any of systems within the network while ensuring the consistency of rights.

Further, a method which requires to be informed of login IDs and passwords for all network devices is inconvenient, and in view of this, to simplify setting of login rights, there has been proposed a technique disclosed in Japanese Patent Laid-Open Publication No. 2008-117052 on the simplification of the method of managing access rights. In this publication, when performing user management in which an organization structure is taken into account, using a directory service, it is possible to delegate the rights of the management of users and groups of a lower organization to a user of an upper organization. Further, even when a change in user's belonging occurs, it is not necessary to change an access control list (ACL) to the network resources or the administrator rights on the organization unit (OU).

However, in the technique in Japanese Patent Laid-Open Publication No. 2003-330824 mentioned above, when the user configures the settings of a plurality of network devices from the PC, it is necessary to individually establish a network connection to each of URLs of the respective network devices. Further, on a Web browser screen displayed on the PC, it is not possible to simultaneously display and edit setting information on the plurality of network devices on one window. As a result, although a common setting information item can be configured at one time, it is necessary to configure different setting information items on a device-by-device basis, which makes it difficult to edit the setting information on the plurality of network devices. Further, in order to simultaneously connect between the PC and the plurality of network devices using HTTP (hypertext transfer protocol) and collectively display and edit input information thereto and output information therefrom on one screen of the PC, an application on the PC-side is required, and there arises a problem of increase in time and labor of the user.

On the other hand, the technique described in Japanese Patent Laid-Open Publication No. 2008-117052 is based on a method of using a directory server or a management server, including a directory service database, which complicates the system configuration and control.

### SUMMARY OF THE INVENTION

The present invention provides a technique that can display a common setting information item and different setting information items on a plurality of network devices on a Web browser on a PC, and collectively configure and edit the setting information items.

Further, the present invention provides a technique that can realize management of access rights between a plurality of network devices by a simple configuration without using a directory server, a management server, or an ACL.

In a first aspect of the present invention, there is provided a network system including a network device and a device controller, wherein the device controller comprises an acquisition unit configured to acquire, from the network device, respective sets of setting information on a plurality of network devices including the network device, wherein the setting information indicates information on settings set to an associated network device, a display unit configured to display a screen for editing the respective sets of setting information on the plurality of network devices, based on the respective sets of setting information acquired by the acquisition unit, and a reception unit configured to receive an editing instruction for editing setting information on at least one of the plurality of network devices via the screen displayed by the display unit, wherein the network device comprises a collection unit configured to collect the setting information from other network devices than the network device within the network system, a transmission unit configured to transmit the setting information collected by the collection unit together with setting information on the own network device to the device controller, and a control unit configured to edit the setting information on the own network device according to the editing instruction received by the reception unit or transmit the editing instruction to the other network devices.

In a second aspect of the present invention, there is provided a device controller that is capable of communicating with a network device, comprising an acquisition unit configured to acquire, from the network device, respective sets of setting information on a plurality of network devices including the network device, wherein the setting information indicates information on settings set to an associated network device, a display unit configured to display a screen for editing the respective sets of setting information on the plurality of network devices, based on the respective sets of setting information acquired by the acquisition unit, and a reception unit configured to receive an editing instruction for editing setting information on at least one of the plurality of network devices via the screen displayed by the display unit.

In a third aspect of the present invention, there is provided a network device that is capable of communicating with a device controller, comprising a collection unit configured to collect setting information on other network devices from the other network devices, wherein the setting information indicates information on settings set to an associated network device, a transmission unit configured to transmit the setting information collected by the collection unit together with setting information on the own network device to the device controller, and a control unit configured to edit the setting information on the own network device according to an editing instruction received from the device controller or transmit the editing instruction to the other network devices.

In a fourth aspect of the present invention, there is provided a method of controlling a network system including a network device and a device controller, comprising causing the device controller to acquire, from the network device, respective sets of setting information on a plurality of network devices including the network device, wherein the setting information indicates information on settings set to an associated network device, display a screen for editing the respective sets of setting information on the plurality of network devices, based on the acquired respective sets of setting information, and receive an editing instruction for editing setting information on at least one of the plurality of network devices via the displayed screen, and the network device to collect the setting information from other network devices than the network device within the network system, transmit the collected setting information together with setting information on the own network device to the device controller, and edit the setting information on the own network device according to the received editing instruction or transmit the editing instruction to the other network devices.

In a fifth aspect of the present invention, there is provided a method of controlling a device controller that is capable of communicating with a network device, comprising causing the device controller to acquire, from the network device, respective sets of setting information on a plurality of network devices including the network device, wherein the setting information indicates information on settings set to an associated network device, display a screen for editing the respective sets of setting information on the plurality of network devices, based on the acquired respective sets of setting information, and receive an editing instruction for editing setting information on at least one of the plurality of network devices via the displayed screen.

In a sixth aspect of the present invention, there is provided a method of controlling a network device that is capable of communicating with a device controller, comprising causing the network device to collect the setting information from other network devices than the network device within the network system, transmit the collected setting information together with setting information on the own network device to the device controller, and edit the setting information on the own network device according to the received editing instruction or transmit the editing instruction to the other network devices.

In a seventh aspect of the present invention, there is provided a network device having a function of enabling a computer connected to a network to configure setting information on the network device, comprising a registration unit configured to register a login ID and a password for each of at least one other network device, wherein the at least other network device for which the login ID and the password are registered and the own network device establish a parent-child relationship, and wherein when the computer logs in to a network device as a parent, the computer is placed in a state also logged in to a network device as a child.

In an eighth aspect of the present invention, there is provided a non-volatile computer-readable storage medium that stores a computer-executable control program for causing a computer to execute a method of controlling a network system including a network device and a device controller, wherein the method comprises causing the device controller to acquire, from the network device, respective sets of setting information on a plurality of network devices including the network device, wherein the setting information indicates information on settings set to an associated network device, display a screen for editing the respective sets of setting information on the plurality of network devices, based on the acquired respective sets of setting information, and receive an editing instruction for editing setting information on at least one of the plurality of network devices via the displayed screen, and the network device to collect the setting information from other network devices than the network device within the network system, transmit the collected setting information together with setting information on the own network device to the device controller, and edit the setting information on the own network device according to the received editing instruction or transmit the editing instruction to the other network devices.

In a ninth aspect of the present invention, there is provided a non-volatile computer-readable storage medium that stores a computer-executable control program for causing a computer to execute a method of controlling a device controller that is capable of communicating with a network device, wherein the method comprises causing the device controller to acquire, from the network device, respective sets of setting information on a plurality of network devices including the network device, wherein the setting information indicates information on settings set to an associated network device, display a screen for editing the respective sets of setting information on the plurality of network devices, based on the acquired respective sets of setting information, and receive an editing instruction for editing setting information on at least one of the plurality of network devices via the displayed screen.

In a tenth aspect of the present invention, there is provided a non-volatile computer-readable storage medium that stores a computer-executable control program for causing a computer to execute a method of controlling a network device that is capable of communicating with a device controller, wherein the method comprises causing the network device to collect the setting information from other network devices than the network device within the network system, transmit the collected setting information together with setting information on the own network device to the device controller, and edit the setting information on the own network device according to the received editing instruction or transmit the editing instruction to the other network devices.

According to the present invention, it is possible to display a common setting information item and individual setting information items on a plurality of network devices on a Web browser on a PC, and collectively configure and edit the setting information items.

Further, according to the present invention, it is possible to realize management of access rights between the plurality of network devices by a simple configuration without using a directory server, a management server or an ACL.

The features and advantages of the invention will become more apparent from the following detailed description taken in conjunction with the accompanying drawings.

### BRIEF DESCRIPTION OF THE DRAWINGS

FIG. 1 is a diagram showing a network system comprising network devices and a device controller according to an embodiment of the present invention.

FIG. 2 is a block diagram showing hardware configuration of each MFP (multifunction peripheral) appearing in FIG. 1.

FIG. 3 is a block diagram showing the configuration of software implementing a controller and the like appearing in FIG. 2.

FIG. 4 is a flowchart of a display process executed by a PC, for displaying setting information on the MFPs.

FIG. 5 is a flowchart of a collection process executed by a first MFP 100A, for collecting setting information on the other MFPs.

FIG. 6 is a flowchart of a configuration and edit process executed by the PC, for configuring and editing setting information on the MFPs.

FIG. 7 is a flowchart of a configuration and edit process executed by the first MFP 100A, for configuring and editing setting information on the MFPs.

FIGS. 8A to 8C are a diagram showing an example of a network environment configuration screen which enables setting information on a plurality of MFPs to be collectively configured.

FIG. 9A is a diagram showing an example of a screen displaying history of print jobs executed by one MFP.

FIG. 9B is a diagram showing an example of a screen displaying history of print jobs executed by the plurality of MFPs.

FIGS. 10A and 10B are diagrams showing an administrative hierarchical relationship between the plurality of MFPs, in which FIG. 10A illustrates a case where a main apparatus has the initiative of setting login rights, and FIG. 10B illustrates a case where a sub apparatus has the initiative of setting login rights.

### DETAILED DESCRIPTION OF THE EMBODIMENTS

The present invention will now be described in detail below with reference to the accompanying drawings showing embodiments thereof.

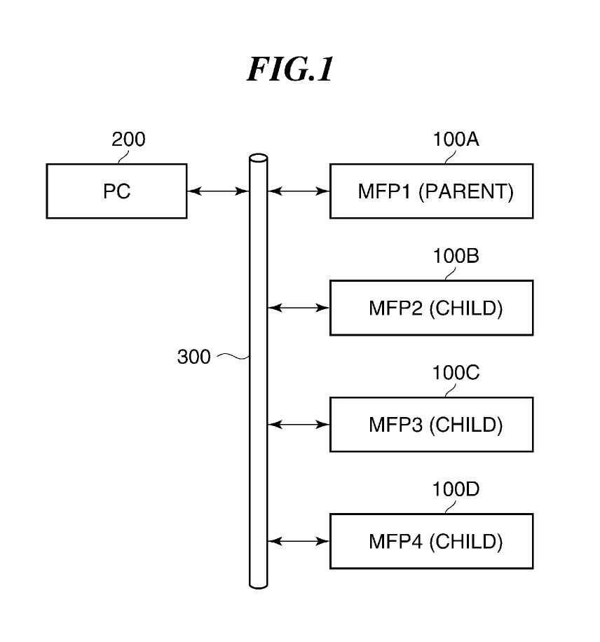

FIG. 1 is a diagram showing a network system comprising network devices and a device controller according to an embodiment of the present invention.

A PC 200 is an example of a device controller which is implemented by a personal computer mainly used by a user. An MFP 100 is an example of a network device which is implemented by a multifunction peripheral provided with a scanner function, a printer function, a facsimile function, and so forth. The PC 200 is connected to a plurality of MFPs 100 (first to fourth MFPs 100A to 100D; the first to fourth MFPs are illustrated as MFP1 to MFP4, and the same applies to the other MFPs) via a network 300, such as a LAN (Local Area Network).

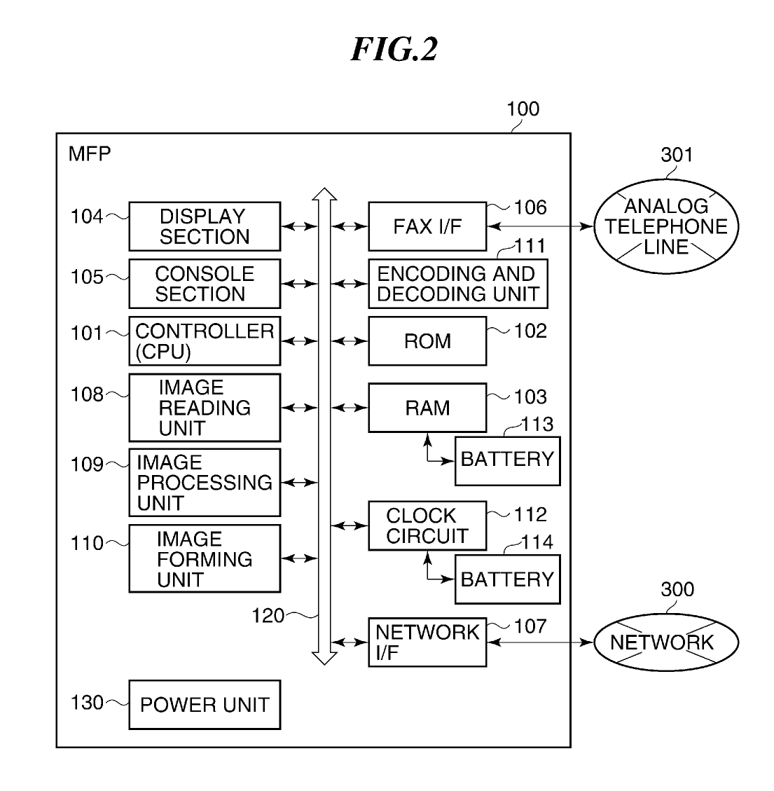

FIG. 2 is a block diagram showing a hardware configuration of the MFP 100 appearing in FIG. 1. Note that although the plurality of MFPs 100 (first to fourth MFPs 100A to 100D) in FIG. 1 each have the same configuration, the configuration of each MFP is not limited to the illustrated example insofar as it can perform operation processing, described hereinafter.

In FIG. 2, a controller 101 is a CPU (central processing unit) that controls overall operations of the MFP 100. A ROM (read only memory) 102 is a memory that stores programs executed by the controller 101, various kinds of data, and so forth.

A RAM (random access memory) 103 is used as a work area for the controller 101, and is also used as a first image memory area used by the copy function, and a second image memory area used by the facsimile function. Further, part or all of the RAM 103 is actuated by a battery 113 provided separately from a power unit 130, referred to hereinafter, and is configured such that stored data and the like can be preserved even when electrical power is not supplied from the power unit 130.

A clock circuit 112 has a function of outputting time information to the outside, and is actuated by a battery 114 provided separately from the power unit 130, referred to hereinafter. A console section 105 has various keys and buttons for operating the MFP 100 by the user. A display section 104 displays various items of information for operating the first MFP 100A, and is formed e.g. by a liquid crystal monitor, a touch panel display, or the like.

A FAX interface 106 has a function of performing FAX communication via an analog telephone line 301. The FAX interface 106 further has a memory reception function of once storing a received image in the RAM 103 without directly outputting the image onto a recording sheet, and then outputting the image onto the recording sheet. The FAX interface 106 further has a timer transmission function of once storing an image to be transmitted in the RAM 103 without immediately transmitting the image, and then transmitting the image at a set time. Further, the FAX interface 106 has a backup function of preserving FAX image data stored in the RAM 103 during a certain time period even when the power of the main unit is turned off.

An image reading unit 108 has the scanner function for reading an original. An image processing unit 109 performs processing for converting image read by the image reading unit 108 and image data to be stored and output. An image forming unit 110 has the printer function for outputting image data onto a recording sheet. In a copying operation, the image forming unit 110 stores and outputs image data read by the image reading unit 108. On the other hand, in a printing operation, the image forming unit 110 stores and outputs image data transferred e.g. from the PC 200.

A network interface 107 has a communication function of transferring image data from the PC 200 to be printed out, and transferring image data read by the image reading unit 108 to the PC 200. The network interface 107 performs communication connection using HTTP (hypertext transfer protocol) by a Web browser operating on the PC 200. Further, the network interface 107 realizes a remote user interface (RUI) function between the PC 200 and the MFP 100.

An encoding and decoding unit 111 has a function of encoding image data read by the image reading unit 108 in a predetermined form in advance before transmitting the image data by the FAX interface 106, and a function of decoding image data received by the FAX interface 106 in a predetermined form in advance before printing out the image data. Further, the encoding and decoding unit 111 also has a function of encoding image data to store pages of image information during copying of the image data, and decoding image data before printing out the image data.

A bus 120 is used for connecting the above-mentioned functional units. The bus 120 includes an address bus for transferring address signals, a control bus for transferring control signals, and a data bus for transferring various items of data. The power unit 130 is a power source for driving the MFP 100.

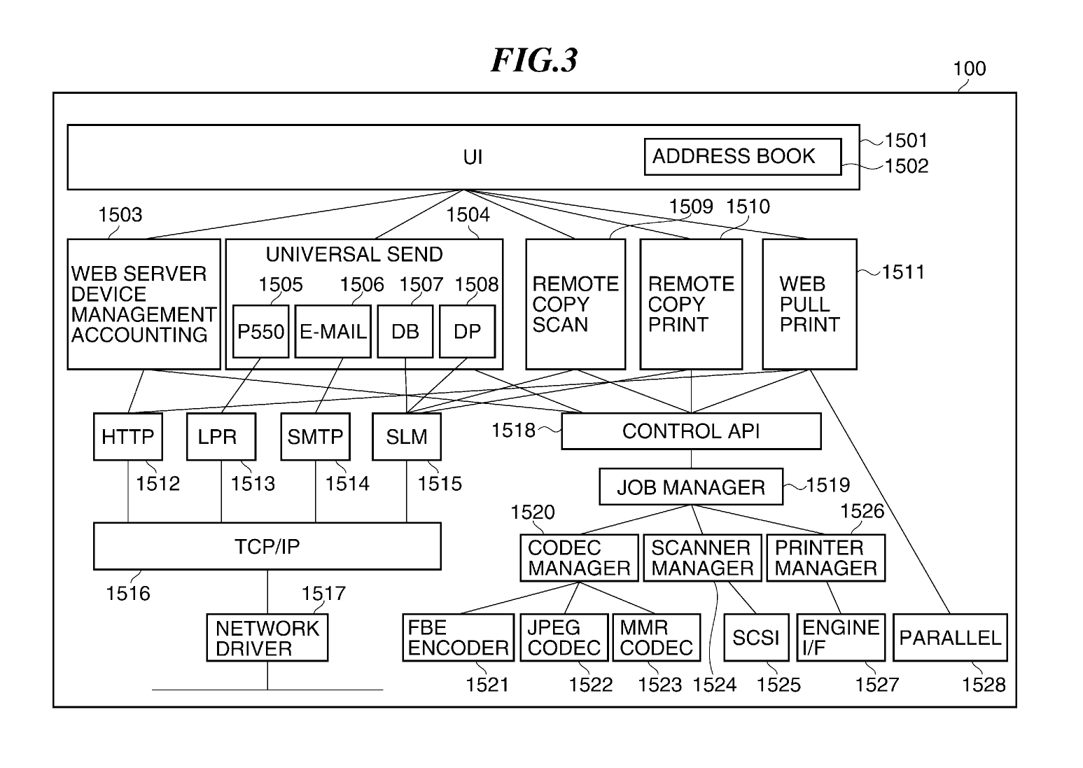

FIG. 3 is a block diagram showing a software configuration implementing the controller 101 and the like appearing in FIG. 2.

A user interface (UI) 1501 is a module for mediating between the apparatus and the user's operation, which operates when the user performs various operations and settings for the MFP 100 using the console section 105. The user interface 1051 transfers input information to various modules, described hereinafter, in response to the user's operation so as to make requests for processing, for data settings or the like.

An address book 1502 is a database module that manages data delivery destinations, communication destinations, and so forth. The contents of the address book 1502 are subjected to processing for addition, deletion, acquisition or the like of data by the user interface 1501, in response to a user's operation, and is made use of by modules, described hereinbelow, as data delivery/communication destination information.

A Web server (Web server device management accounting) 1503 is a module which notifies a Web client (e.g. the PC 200) of management information on the MFP 100 in response to requests from the Web client. The management information on the MFP 100 is read by universal send 1504, remote copy scan 1509, remote copy print 1510, and a control API 1518, and is sent to the Web clients by HTTP 1512, TCP/IP 1516, and a network driver 1517, referred to hereinafter.

Further, the Web server 1503 generates information to be passed to the Web clients as so-called Web page (home page) format data, such as HTML. At this time, Java (registered trademark), a CGI program, or the like is used as required.

The universal send 1504 is a module which controls data distribution, and distributes data designated by the user via the user interface 1501 to a communication (output) destination designated by the user. For example, when the user instructs data to be generated for distribution using the scanner function, the universal send 1504 causes the control API 1518 to operate the image reading unit 108 to generate the data.

Printer (P550) 1505 is a module which operates within the universal send 1504 when a printer is designated as an output destination. E-mail 1506 is a module which operates within the universal send 1504 when an E-mail address is designated as a communication destination. Database 1507 is a module which operates within the universal send 1504 when a database (DB) is designated as an output destination. A DP 1508 is a module which operates within the universal send 1504 when an MFP similar to the MFP 100 is designated as an output destination.

The remote copy scan 1509 is a module which outputs image information read by the image reading unit 108 using the scanner function equipped with the MFP to another MFP, to thereby cause the other MFP to perform the same processing as the copy function that can be realized by the MFP 100 alone (the image reading unit 108 and the image forming unit 110).

The remote copy print 1510 is a module which prints out image information acquired by another MFP as an input source (image information read by the image reading unit 108), by the image forming unit 110 using the own apparatus, to thereby perform the same processing as the copy function realized by the MFP 100. Web pull print 1511 is a module for reading out information on various home pages on the Internet or an intranet by designating URLs, and printing the information by the image forming unit 110.

The HTTP 1512 is a module which operates when the MFP 100 communicates using the HTTP, and provides communication functions for the Web server 1503 and the Web pull print 1511. Lpr (line printer daemon protocol) 1513 is a module which provides a communication function for the printer 1505 within the universal send 1504, using the TCP/IP 1516.

SMTP 1514 is a module which provides a communication function for the E-mail 1506 within the universal send 1504, using the TCP/IP 1516. An SLM (salutation manager) 1515 is a module which provides communication functions for the database 1507 and the DP 1508 within the universal send 1504, the remote copy scan 1509, and the remote copy print 1510, using the TCP/IP 1516.

The TCP/IP 1516 is a module which provides a network communication function for each of the above described modules using the network driver 1517. The network driver 1517 is a module which controls system parts physically connected to the network.

The control API 1518 provides interface with downstream modules including a job manager 1519, referred to hereinafter, for the upstream modules including the universal send 1504. The job manager 1519 interprets various kinds of processing designated by the above-mentioned modules via the control API 1518, and gives instructions to modules (1520, 1524, and 1526), referred to hereinafter. Further, the job manager 1519 performs centralized control of various jobs executed within the MFP 100, including control of a FAX job.

A CODEC manager 1520 is a module which performs management and control of various types of data compression and expansion during processing designated by the job manager 1519. An FBE encoder 1521 is a module which compresses data scanned in scan processing carried out by the job manager 1519 or the scan manager 1524, using an FBE format.

JPEG CODEC 1522 is a module used to JPEG-compress data scanned in scan processing carried out by the job manager or the like, and expand JPEG-compressed print data in print processing carried out by a print manager. MMR (Modified Modified Read) CODEC 1523 is a module used to MMR-compress data scanned in scan processing carried out by the job manager or the like, and expand MMR-compressed print data to be output to the printer in print processing carried out by the print manager.

The scan manager 1524 is a module which performs management and control of scan processing designated by the job manager 1519. A SCSI driver 1525 is a module which provides communication interface between the scan manager 1524 and the image reading unit 108 internally connected to the MFP 100. The print manager 1526 performs management and control of print processing designated by the job manager 1519. An engine interface 1527 is a module which provides interface between the print manager 1526 and the image forming unit 110. A parallel port driver 1528 is a module which provides interface when the Web pull print 1511 outputs data to an output device, not shown, via a parallel port.

Next, a detailed description will be given of the address book 1502.

The address book 1502 is stored in a nonvolatile memory (a nonvolatile memory, a hard disk or the like) within the MFP 100, and the features of other apparatuses connected to the network are written in the address book 1502. More specifically, the address book 1502 contains pieces of information listed as follows:

(1) formal name and alias name of each apparatus

(2) network address of each apparatus

(3) network protocols compatible with each apparatus

(4) document formats compatible with each apparatus

(5) compression types compatible with each apparatus

(6) image resolutions compatible with each apparatus

(7) information on sizes of feedable sheets and sheet feeding cassettes for printer apparatuses

(8) names of folders which can store documents, for server (computer) apparatuses

Each of applications described below is capable of discriminating the features of a distribution destination based on information written in the address book 1502. By referring to address book 1502, the MFP 100 can transmit data. For example, a remote copy application discriminates information on a resolution compatible with an apparatus designated as a distribution destination by referring to the address book 1502, and according to the determination, compresses binary image data read by the image reading unit 108 using the known MMR-compression. Then, the MMR-compressed data is converted to a known TIFF (tagged image file format) data, and is transmitted to a printer device on the network via the SLM 1515.

Although not described in detail, the SLM 1515 is a kind of network protocol containing device control information, called a known “salutation manager”.

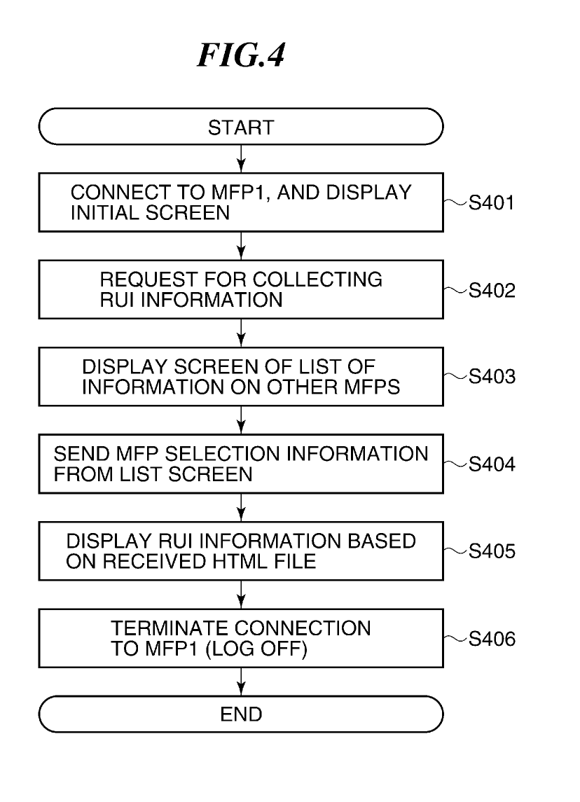

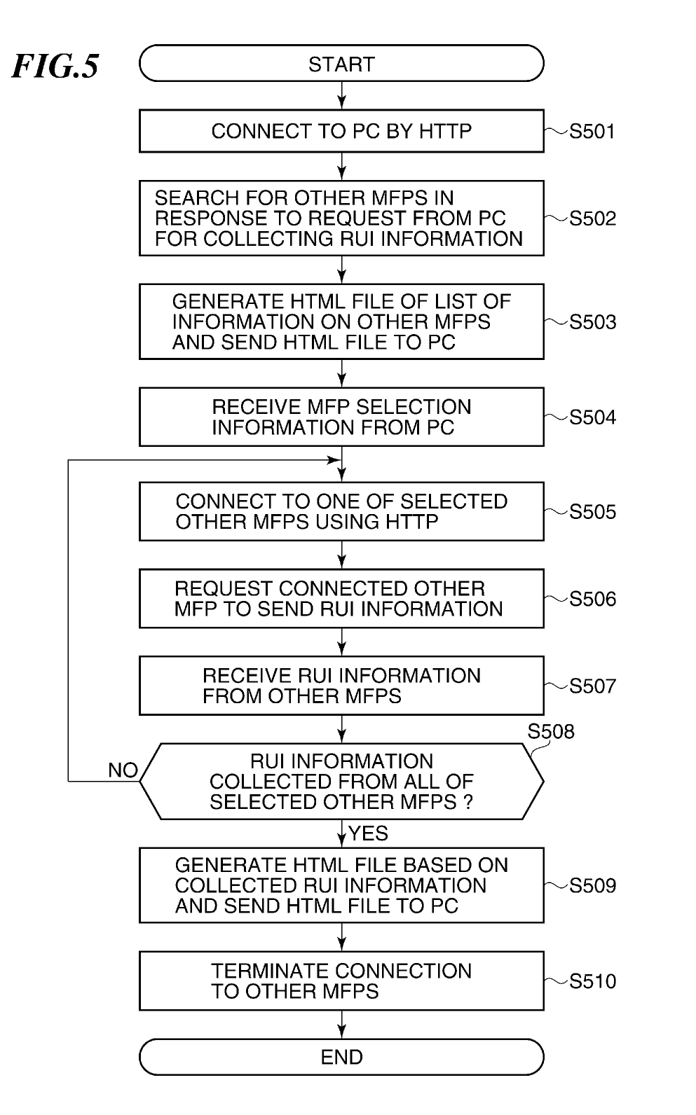

Next, a description will be given of a process executed by the first MFP 100A as a main apparatus in the network system shown in FIG. 1, for collecting MFP setting information from a plurality of MFPs, e.g. second to fourth MFPs 100B to 100D, and collectively redirecting the setting information to the PC 200, with reference to FIGS. 4 and 5.

FIG. 4 is a flowchart of a display process for displaying MFP setting information in the PC 200.

In a step S401, when the user inputs a predetermined URL (e.g. an IP address of the first MFP 100A) in the column of the address on a screen displayed by the Web browser on the PC 200, the PC 200 and the first MFP 100A are connected to each other using HTTP. Then, a screen for login to the RUI is displayed on the PC 200. When the user performs a login operation on the screen for login to the RUI, an initial screen of the RUI is displayed on the PC 200 (step S401).

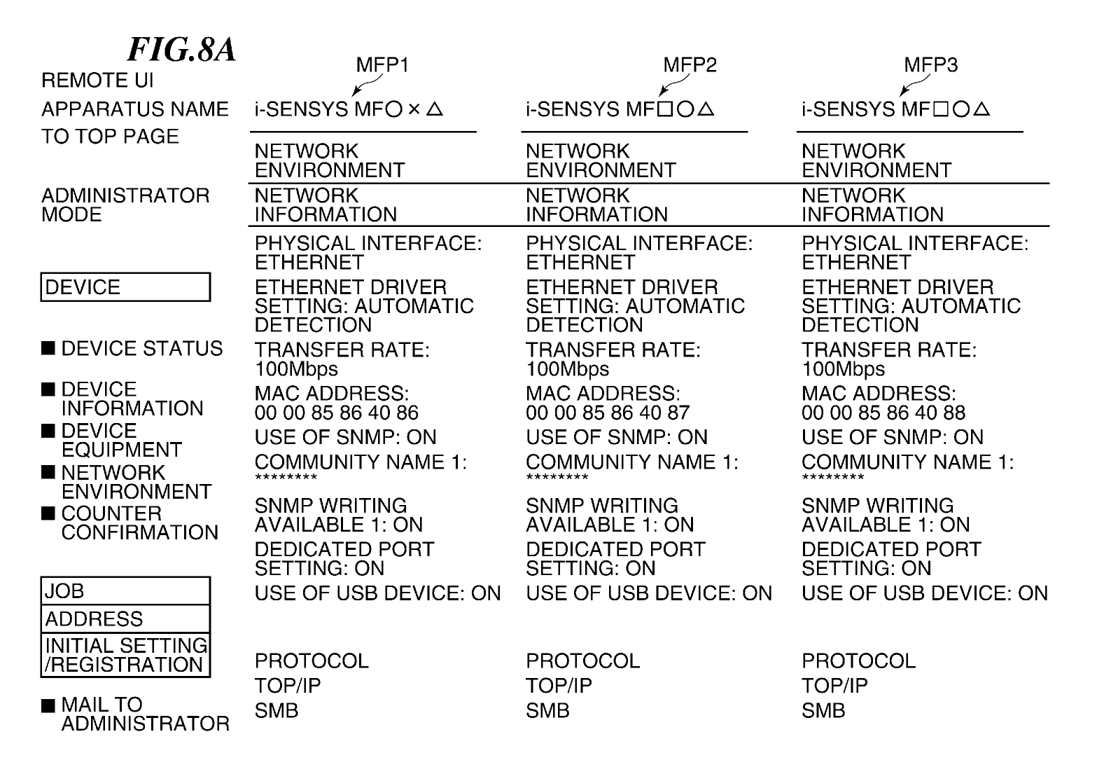

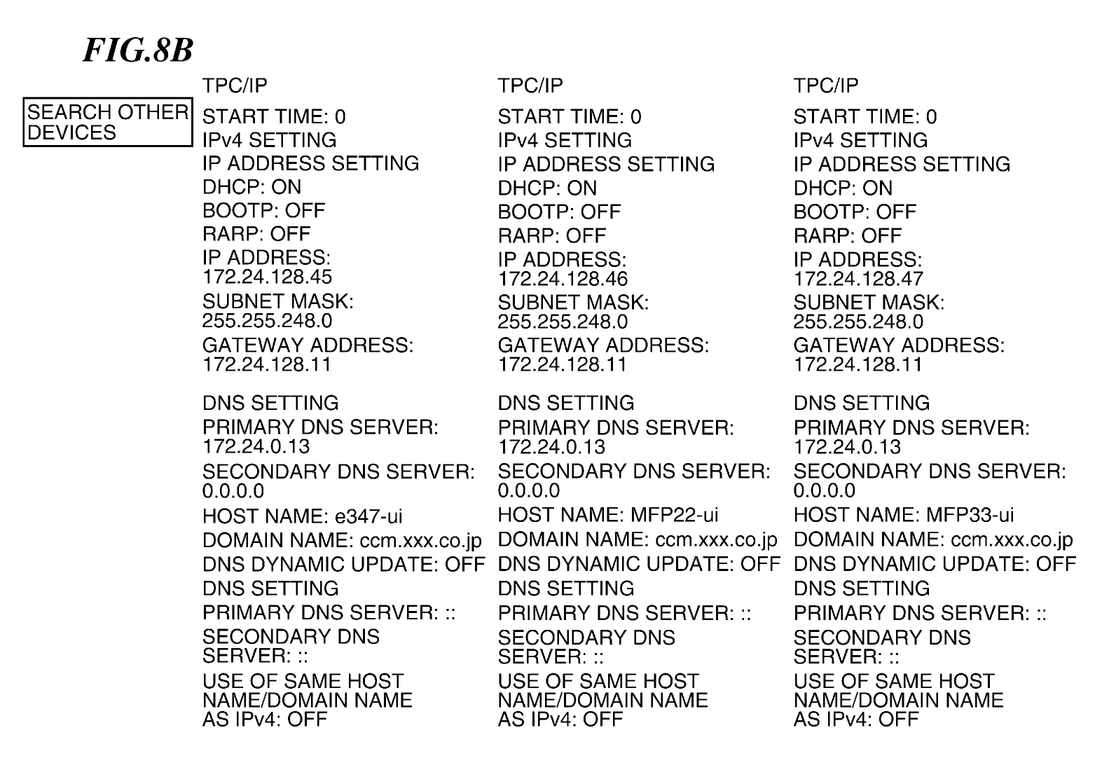

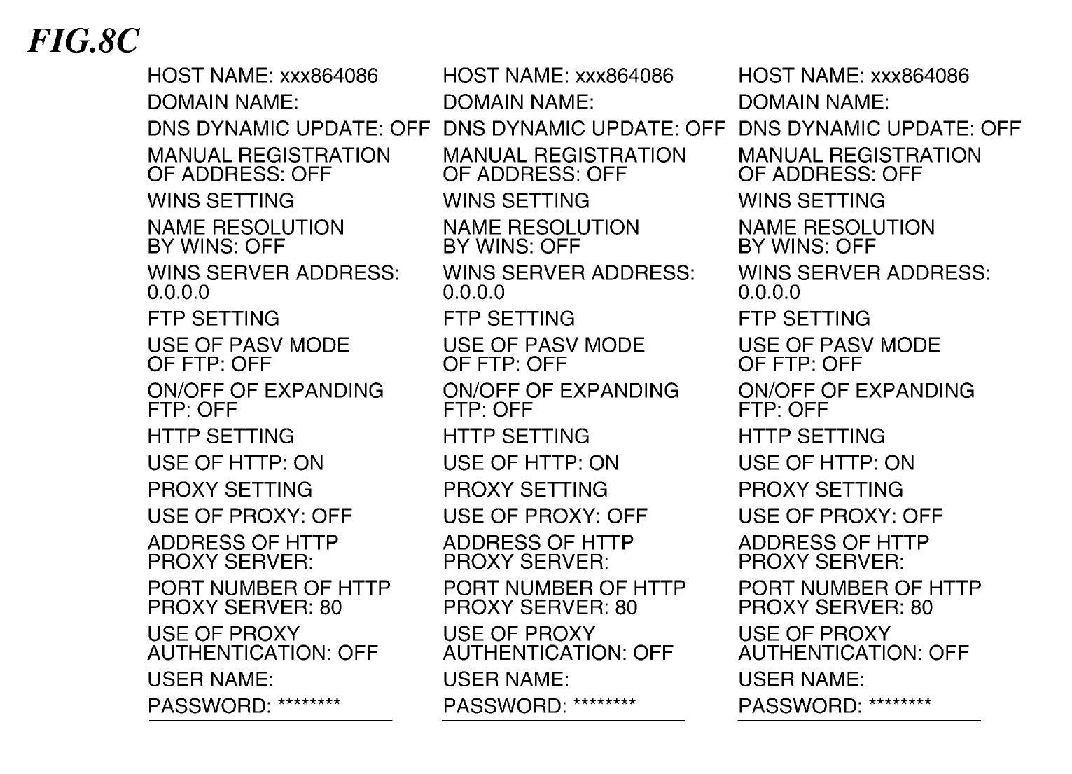

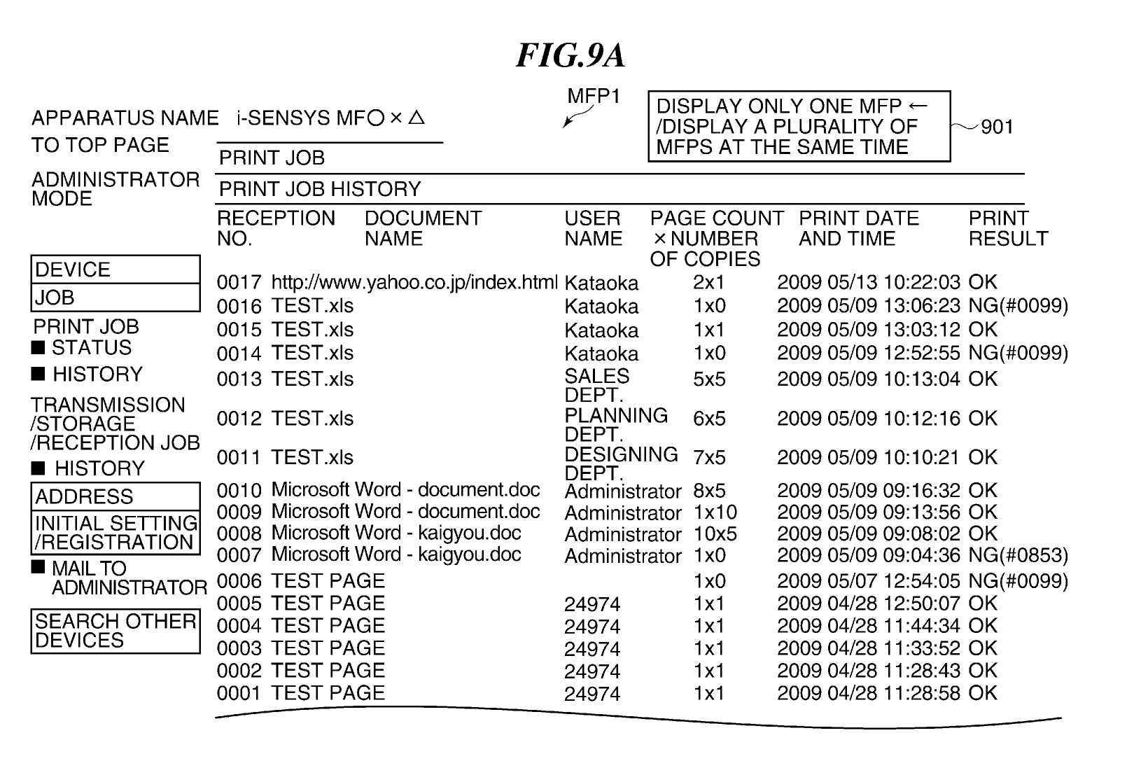

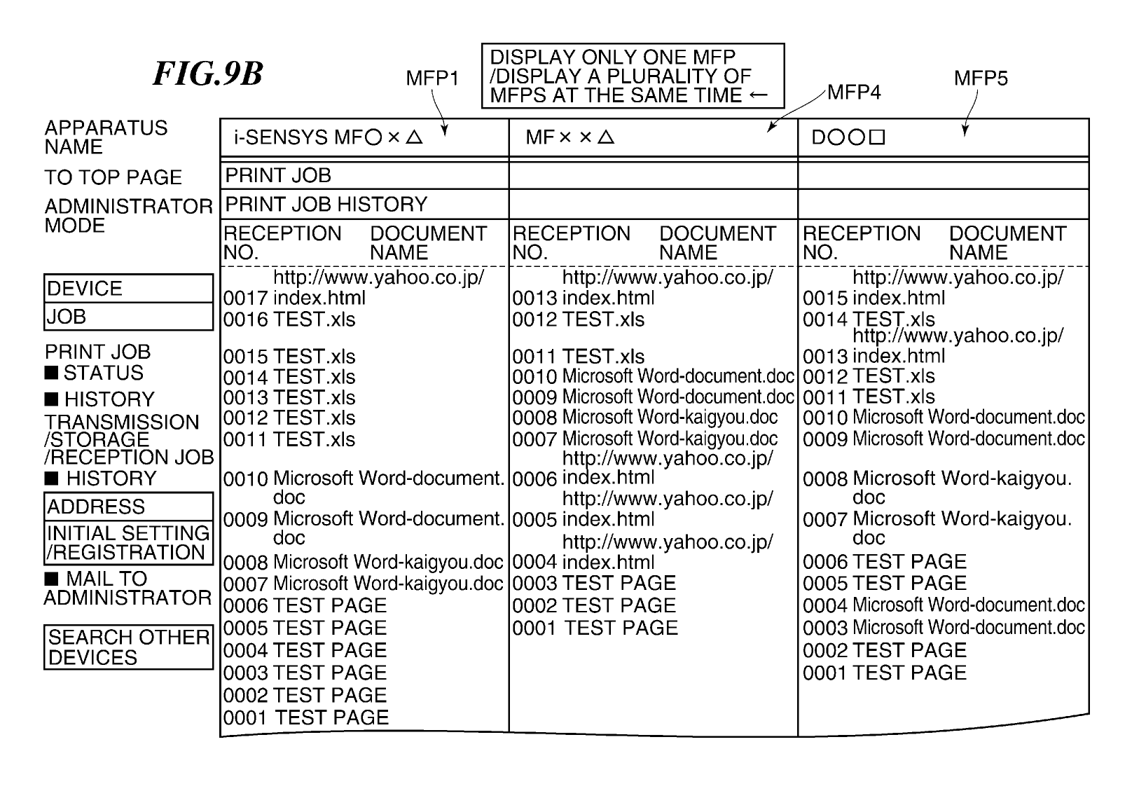

Next, in a step S402, the Web browser on the PC 200 makes a request to the first MFP 100A for collecting setting information on the other MFPs except the first MFP 100A (the second MFP 100B, the third MFP 100C, the fourth MFP 100D . . . ). This request is started by clicking a “search other device” button by the user on the screen shown in FIGS. 8A to 8C and 9A and 9B, described hereinafter. The MFP setting information includes e.g. device management information for displaying and managing the printer conditions, job management information for displaying and operating jobs, and device setting information for displaying and changing the settings of the MFP.

Next, in a step S403, the Web browser displays a screen of a list including the names and IP addresses of the other MFPs based on the HTML file received from the first MFP 100A.

Next, in a step S404, from the displayed list screen, the user selects and designates one or more MFPs which the user desires to access, out of the plurality of MFPs connected to the network. The Web browser accepts selection of the other MFP(s) and transmits MFP selection information indicative of selection of the other MFP(s) selected by the user to the first MFP 100A.

Next, in a step S405, the Web browser displays the setting information as shown in FIGS. 8A to 8C based on the HTML file received from the first MFP 100A.

Next, in a step S406, the web browser terminates the connection to (logs off) the first MFP 100A using HTTP in response to the user's operation, followed by terminating the present process.

FIG. 5 is a flowchart of a collection process executed by the first MFP 100A, for collecting setting information on the other MFPs.

In a step S501, the first MFP 100A is connected to the PC 200 using HTTP in response to an access from the PC 200.

Next, in a step S502, the first MFP 100A receives a request from the PC 200, for collecting setting information on the other MFPs except the first MFP 100A, and searches for the other MFPs (the second MFP 100B, the third MFP 100C, the fourth MFP 100D, . . . ) connected to the network 300.

Next, in a step S503, the first MFP 100A generates a HTML file of a list of information containing the respective names and IP addresses of the MFPs found by the search, and sends the HTML file to the PC 200.

Next, in a step S504, the first MFP 100A receives selection information indicative of selection of other MFPs from the PC 200, and is connected to one of the other MFPs indicated in the selection information using HTTP (step S505).

Next, in a step S506, the first MFP 100A logs into the one MFP via the RUI, and makes a request for transmitting the setting information on the one MFP. When the one MFP receives the request from the first MFP 100A, the one MFP sends the HTML file of the setting information to the first MFP 100A using HTTP.

Next, in a step S507, the first MFP 100A receives the HTML file of the setting information from the one MFP.

Next, in a step S508, the first MFP 100A determines whether or not the setting information has been collected from all of the MFPs indicated in the selection information on the other MFPs. As a result, if the setting information has been collected from all of the MFPs indicated in the selection information on the other MFPs, the process proceeds to a step S509, whereas if not, the steps S505 to S508 are repeated.

In the step S509, the first MFP 100A generates (reconstructs) one HTML file based on at least one item of setting information collected from the other MFPs, and sends the HTML file to the PC 200 using HTTP.

Next, in a step S510, the first MFP 100A terminates the connection to (logs off) the other MFPs, followed by terminating the present process.

As described above, by executing the processes in FIGS. 4 and 5, it is possible to acquire the setting information on the other second to fourth MFPs 100B to 100D as child MFPs, only by accessing the first MFP 100A as a parent apparatus by the PC 200, which enables the user to collectively view the setting information on the plurality of other MFPs on the PC 200.

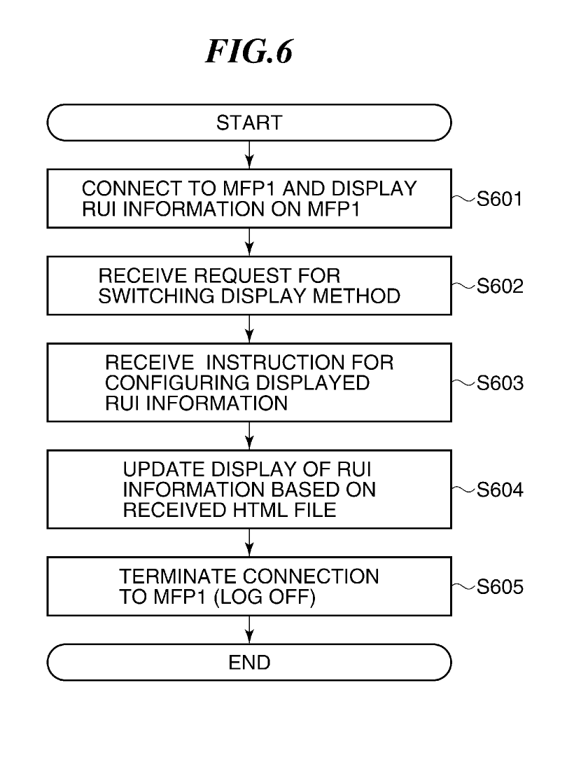

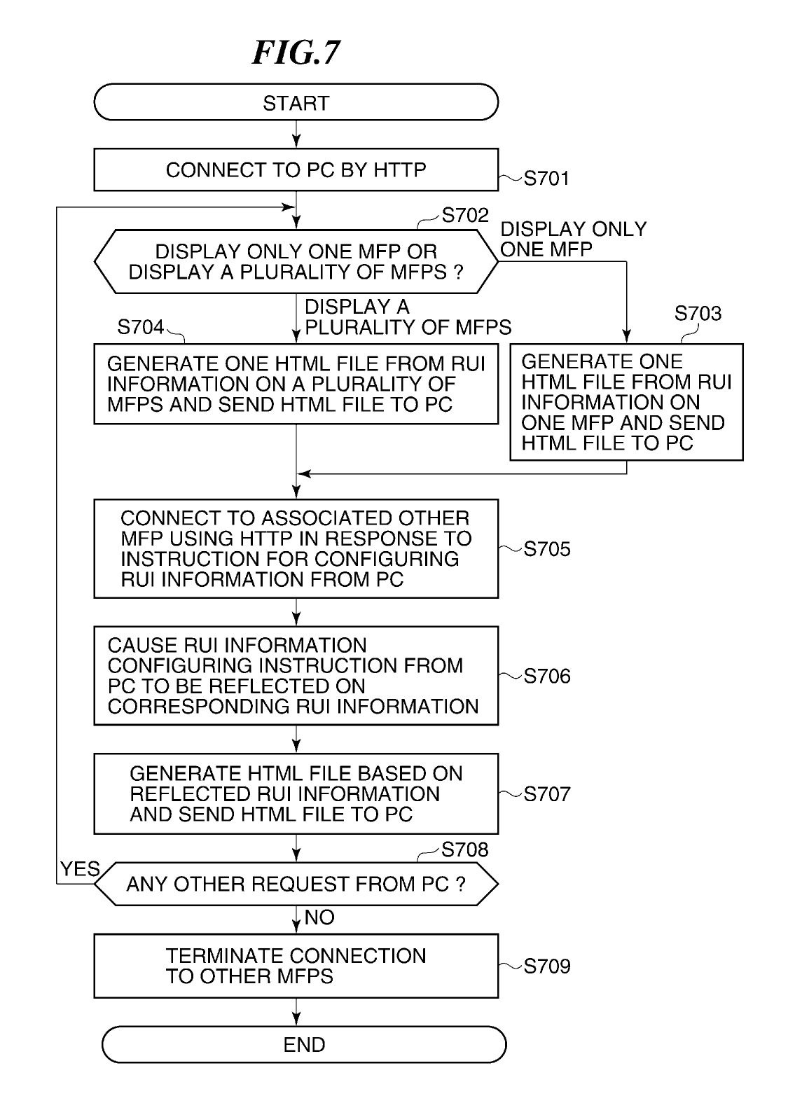

Next, a description will be given of a process for configuring the setting information on the plurality of other MFPs from the PC 200 via the first MFP 100A as the parent apparatus in the network system in FIG. 1 with reference to FIGS. 6 and 7.

FIG. 6 is a flowchart of a configuration and edit process executed by the PC 200, for configuring and editing setting information on the MFPs.

In a step S601, when the user inputs a predetermined URL (e.g. the IP address of the first MFP 100A) in an address field on the screen displayed by the Web browser on the PC 200, the PC 200 and the first MFP 100A are connected to each other using HTTP. Then, a login screen of the RUI is displayed on the PC 200. When the user performs an login operation on the login screen, it is assumed here that the setting information on the first MFP 100A is displayed on the screen of the PC 200 (step S601).

Next, in a step S602, the web browser on the PC 200 receives a request for switching a display method such that the setting information on the plurality of other MFPs is displayed on the screen.

Next, in a step S603, the Web browser receives a request (configuration instruction) to the first MFP 100A as the parent apparatus for configuring the setting information on the first MFP 100A and the other MFPs (the second MFP 100B, the third MFP 100C, the fourth MFP 100D, . . . ). The user selects cells for data of setting values and inputs values therein on the display screen of the PC 200, whereby values can be set to individual MFPs or a common value can be set to a plurality of MFPs, as desired. Some setting values of setting information on the MFPs are common between the MFPs, and others are specific to each of the MFPs.

Next, in a step S604, the Web browser updates the display of the setting information based on the HTML file received from the first MFP 100A.

Next, in a step S605, the Web browser terminates the connection to (logs off) the first MFP 100A using HTTP in response to the user's operation, followed by terminating the present process.

FIG. 7 is a flowchart of a configuration and edit process executed by the first MFP 100A, for configuring and editing setting information on the MFPs.

In a step S701, the first MFP 100A is connected to the PC 200 using HTTP in response to the access from the PC 200.

Next, in a step S702, the first MFP 100A determines whether the request from the PC 200 for switching the display is a request for displaying the setting information on only one MFP or that for displaying the setting information on the plurality of MFPs. If it is determined that the first MFP 100A determines that the request is for displaying the setting information on only one MFP, the process proceeds to a step S703, whereas the first MFP 100A determines that the request is for displaying the setting information on the plurality of MFPs, the process proceeds to a step S704.

In the step S703, the first MFP 100A generates (reconstructs) an HTML file based on the setting information on the first MFP 100A, and sends the HTML file to the PC 200 to be displayed on the screen. In the step S704, the first MFP 100A generates (reconstructs) one HTML file based on the setting information on the plurality of other MFPs connected to the network, which has been collected by the first MFP 100A, and then sends the HTML file to the PC 200 using HTTP to cause the same to be displayed on the screen. The user thus performs operation while viewing the screen on the PC, whereby it is possible for the user to alternately switch between a conventional access screen to the one MFP and an access screen to the plurality of MFPs, with one click.

Next, in a step S705, in response to the request (configuration instruction) sent from the PC 200 in the step S603, the first MFP 100A is connected to the other MFPs using HTTP.

Next, in a step S706, the first MFP 100A causes the configuration instruction sent from the PC 200 to be reflected on the setting information on the other MFPs. For example, when the first MFP 100A receives setting values or setting change values related to the setting information on the plurality of MFPs from the PC 200, the first MFP 100A breaks up the values into respective sets of setting values or setting change values concerning setting information on the individual MFPs. Then, the first MFP 100A transfers each set of setting values or setting change values to an associated one of the MFPs, to thereby cause the set and edited setting information to be reflected on each associated MFP.

Next, in a step S707, the first MFP 100A generates (reconstructs) an HTML file based on the setting information on the other MFPs, which has had the configuration instruction reflected thereon in the step S706, and then sends the HTML file to the PC 200. Then, if there is any other request from the PC 200 in a step S708 (YES to the step S708), the process returns to the step S702, wherein the steps S702 to S708 are repeatedly executed according to the configuration instruction from the PC 200 by the user's operation.

In a step S709, the first MFP 100A terminates the connection to (logs off) the other MFPs, and at the same time terminates the connection to (logs off) the PC 200.

According to the above-described processes, when the user configures and edits the setting information on the plurality of MFPs from the PC, only by accessing one MFP as the parent apparatus, it is possible to access the setting information on the plurality of MFPs, which enables the user to easily perform the configuration and editing of the setting information on the MFPs.

FIGS. 8A to 8C illustrate an example of RUI setting information displayed on the PC 200, and is an example of a network environment configuration screen which enables RUI setting information on the plurality of MFPs to be collectively configured.

In FIGS. 8A to 8C, respective sets of setting information items related to the network environments of the first to third MFPs 100A to 100C are displayed side by side. As illustrated in FIGS. 8A to 8C, in the network environments used by one user, many of items of settings of the network environments of the respective MFPs are the same. For example, in the illustrated example, the settings are different between the network environments only in the apparatus name, the MAC address, and the IP address. In such a case, it is inefficient to perform connection using the RUI to individually configure the settings on an MFP-by-MFP basis, but it is efficient to collectively set the same settings to the plurality of apparatuses. In the present embodiment, the configuration screen is configured such that an MFP to be edited can be selected by clicking a scroll tab, and an editing operation can be easily performed e.g. by area selection using a mouse and a copy and paste operation using a copy tab and a paste tab.

The above-described operation of setting and editing the RUI setting information is realized by the steps S603 and S604 in FIG. 6, and the steps S705 to S707 in FIG. 7.

FIGS. 9A and 9B illustrate an example of the RUI setting information displayed on the PC 200. FIG. 9A illustrates an example of a screen displaying history of print jobs executed by one MFP (the first MFP 100A in FIG. 9A), and FIG. 9B illustrates an example of a screen displaying history of print jobs executed by the plurality of MFPs (the first, fourth, and fifth MFPs 100A, 100D, and 100E).

In the network system in which the MFPs and the PC are connected via a transmission medium, such as a network, the history of image output jobs which were input to the MFPs and subjected to image output can be acquired and displayed on the PC.

When a “display only one MFP/display a plurality of MFPs at the same time” button 901 is clicked on the screen illustrated in FIG. 9A, the screen is switched to the one illustrated in FIG. 9B. On the other hand, the button 901 is clicked in a state where one of the three MFPs is selected on the screen illustrated in FIG. 9B, the screen is switched to the one illustrated in FIG. 9A. As mentioned above, by clicking the “display only one MFP/display a plurality of MFPs at the same time” button 901, it is possible to alternately switch between the screens in FIGS. 9A and 9B. These screen switching operations are realized by the step S602 in FIG. 6, and the steps S702 to S704 in FIG. 7.

As described above, when the user configures and edits the setting information on the plurality of MFPs from the PC, by accessing one MFP as the parent apparatus, the setting information on the plurality of MFPs can be accessed, which facilitates configuration and edition of the setting information. Further, according to the user's operation, the conventional display of one MFP and the collective display of the plurality of MFPs can be alternately switched by one click, and hence the user can change the display according to the situation.

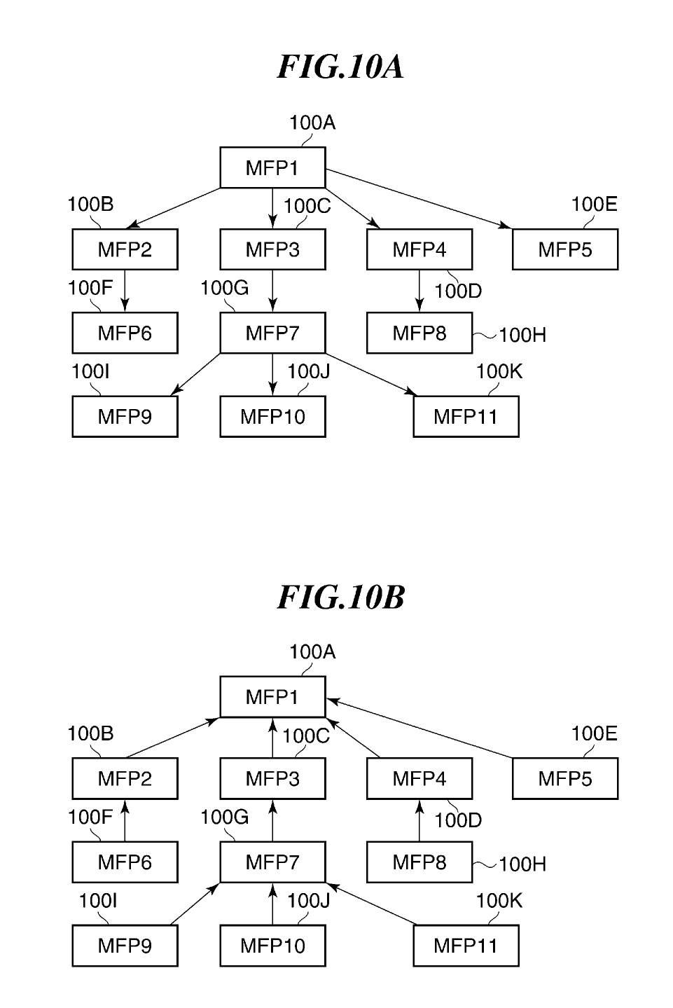

Next, a description will be given of an example of a collection method when the first MFP 100A collects the RUI setting information from the plurality of other MFPs with reference to FIGS. 10A and 10B.

FIG. 10 illustrates an administrative hierarchical relationship between the plurality of MFPs, FIG. 10A illustrates an example of a case where a main (parent) apparatus has the initiative of setting login rights, and FIG. 10B illustrates an example of a case where a sub (child) apparatus has the initiative of setting login rights. In the illustrated example, it is assumed that the main (parent) apparatus is the first MFP 100A, and the sub (child) apparatuses are the second to eleventh MFPs 100B to 100K.

In FIG. 10A, the MFP as the parent apparatus (first MFP 100A) has rights to log in by RUI to a plurality of other MFPs (second to eleventh MFPs 100B to 100K). By causing the first MFP 100A to register and manage the login IDs and passwords for the other second to eleventh MFPs for RUI, the first MFP 100A has the rights to log in by RUI to the second to eleventh MFPs 100B to 100K. This requires the user only to store the login ID and password for the first MFP 100A for the RUI function without storing the login IDs and passwords for the plurality of MFPs for RUI.

For example, the seventh MFP 100G registers the ninth MFP 1001 as a child apparatus of the RUI. Further, the third MFP 100C registers the seventh MFP 100G as a child apparatus of the RUI. Further, the first MFP 100A registers the third MFP 100C as a child apparatus for RUI. In this case, the first MFP 100A is automatically allowed to log in to the ninth MFP 1001 by RUI. That is, the user who can log in to the first MFP 100A by the administrator rights can also access the third MFP 100C, the seventh MFP 100G, and the ninth MFP 1001 without knowing the login IDs and passwords for these apparatuses for RUI.

As described above, by delegation of login rights, the user need not know the login IDs and passwords for all of the apparatuses, which reduces the burden on the user. Further, this eliminates the need to set the login IDs and passwords for all of apparatuses to the main apparatus.

In FIG. 10B, by giving rights to view and edit RUI setting information on the own apparatus to other apparatuses, a parent-child relationship is established between apparatuses. More specifically, the rights to log in by RUI to each MFP are ranked to form a hierarchical structure configured such that a higher-ranked apparatus can automatically log in to a lower-ranked apparatus, whereas a lower-ranked apparatus cannot log in to a higher-ranked apparatus. For example, an apparatus in a business operation division center is set as a parent apparatus, apparatuses in respective departments are set as child apparatuses, and apparatuses in respective sections are grand-child apparatuses. Each child apparatus (lower-ranked apparatus) is configured to be capable of registering the parent apparatus (higher-ranked apparatus) such that the child apparatus give the rights to the parent apparatus. It is assumed that even when a lower apparatus is connected to the PC, the existence and the IP address of a higher apparatus are notified to the PC.

For example, the ninth MFP 100I registers the seventh MFP 100G as the parent apparatus for RUI. The seventh MFP 100G registers the third MFP 100C as the parent apparatus for RUI. The third MFP 100C registers the first MFP 100A as the parent apparatus for RUI. In this case, the first MFP 100A is automatically allowed to log in to the MFP 9 by RUI. The user who can log in to the first MFP 100A by the administrator rights can also access the third MFP 100C, the seventh MFP 100G, and the ninth MFP 100I without knowing the login IDs and passwords for these apparatuses for RUI.

As described above, only by logging in to the higher-ranked apparatus from the PC, the user is automatically authorized to log in to the lower-ranked apparatuses having a parent-child relationship with the higher-ranked apparatus, and hence the user does not need to individually log in to the lower-ranked apparatuses. Further, it is only required that each child apparatus sets a parent apparatus, but the parent apparatus is not required to perform settings for child apparatuses. The user is automatically authorized to log in to apparatuses lower in rank than the apparatus which the user is authorized to use. Further, the user does not need to know the login IDs and passwords for the apparatuses which become child apparatuses. It is not necessary for the apparatuses which become child apparatuses to notify the user of the login IDs and passwords for the own apparatuses, which improves security as well. When the parent-child relationship is cancelled, the child apparatus is no longer logged in by a user of any other apparatus.

According to the above-described embodiment, the device controller (PC 200) accesses one (first MFP 100A) of a plurality of network devices (MFPs) using the Web browser. Then, the device controller acquires the setting information on the network devices on the network, including the accessed network device, from the accessed network device, and displays the acquired setting information. Further, the device controller receives an instruction for configuring and editing the displayed setting information of at least one network device. On the other hand, the accessed network device collects the setting information from the other network devices via the network in response to the access from the device controller to generate one HTML file based on the collected setting information, and transmits the HTML file to the device controller using HTTP. Then, the setting information configured or edited on the device controller is broken up into respective sets of setting information for the other network devices to generate HTML files, and the HTML files are transmitted to the other network devices associated therewith to thereby cause the setting information to be reflected on the other network devices, respectively. Thus, one of the plurality of MFPs serves as a Web server, which eliminates the need for a directory server, a management server, or an ACL (access control list), whereby it is possible to form the user management system for RUI with a simple construction.

Although in the present embodiment, the description has been given of the MFP as an example of the network device, this is not limitative, but the network device may be a printer or a facsimile machine having a single function, or a scanner.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-142687, filed Jun. 23, 2010, which is hereby incorporated by reference herein in its entirety.

What is claimed is:

1. A network system including a network device and a device controller,
wherein the device controller comprises:
an acquisition unit configured to acquire, from the network device, respective sets of setting information on a plurality of network devices including the network device, wherein the setting information indicates information on settings set to an associated network device;
a display unit configured to display a screen for editing the respective sets of setting information on the plurality of network devices, based on the respective sets of setting information acquired by said acquisition unit; and
a reception unit configured to receive an editing instruction for editing setting information on at least one of the plurality of network devices via the screen displayed by said display unit,
wherein the network device comprises:
a collection unit configured to collect the setting information from other network devices than the network device within the network system;
a transmission unit configured to transmit the setting information collected by said collection unit together with setting information on the own network device to the device controller; and
a control unit configured to edit the setting information on the own network device according to the editing instruction received by said reception unit or transmit the editing instruction to the other network devices.

2. The network system according to claim 1, wherein said display unit displays the screen by switching between a screen for editing setting information on one of the network devices, and a screen for collectively editing setting information on the plurality of network devices, according to a user's operation.

3. A device controller that is capable of communicating with a network device, comprising:
an acquisition unit configured to acquire, from the network device, respective sets of setting information on a plurality of network devices including the network device, wherein the setting information indicates information on settings set to an associated network device;
a display unit configured to display a screen for editing the respective sets of setting information on the plurality of network devices, based on the respective sets of setting information acquired by said acquisition unit; and
a reception unit configured to receive an editing instruction for editing setting information on at least one of the plurality of network devices via the screen displayed by said display unit.

4. A network device that is capable of communicating with a device controller, comprising:
a collection unit configured to collect setting information on other network devices from the other network devices, wherein the setting information indicates information on settings set to an associated network device;
a transmission unit configured to transmit the setting information collected by said collection unit together with setting information on the own network device to the device controller; and
a control unit configured to edit the setting information on the own network device according to an editing instruction received from the device controller or transmit the editing instruction to the other network devices.

5. A method of controlling a network system including a network device and a device controller, comprising causing:
the device controller to:
acquire, from the network device, respective sets of setting information on a plurality of network devices including the network device, wherein the setting information indicates information on settings set to an associated network device;
display a screen for editing the respective sets of setting information on the plurality of network devices, based on the acquired respective sets of setting information; and
receive an editing instruction for editing setting information on at least one of the plurality of network devices via the displayed screen, and
the network device to:
collect the setting information from other network devices than the network device within the network system;
transmit the collected setting information together with setting information on the own network device to the device controller; and
edit the setting information on the own network device according to the received editing instruction or transmit the editing instruction to the other network devices.

6. A method of controlling a device controller that is capable of communicating with a network device, comprising causing the device controller to:
acquire, from the network device, respective sets of setting information on a plurality of network devices including the network device, wherein the setting information indicates information on settings set to an associated network device;
display a screen for editing the respective sets of setting information on the plurality of network devices, based on the acquired respective sets of setting information; and
receive an editing instruction for editing setting information on at least one of the plurality of network devices via the displayed screen.

7. A method of controlling a network device that is capable of communicating with a device controller, comprising causing the network device to:
collect the setting information from other network devices than the network device within the network system;
transmit the collected setting information together with setting information on the own network device to the device controller; and
edit the setting information on the own network device according to the received editing instruction or transmit the editing instruction to the other network devices.

8. A network device having a function of enabling a computer connected to a network to configure setting information on the network device, comprising:
a registration unit configured to register a login ID and a password for each of at least one other network device,
wherein the at least other network device for which the login ID and the password are registered and the own network device establish a parent-child relationship, and
wherein when the computer logs in to a network device as a parent, the computer is placed in a state also logged in to a network device as a child.

9. The network device according to claim 8, wherein the at least one other network device and the own network device are ranked in rights of login to the function, such that a higher-ranked network device is automatically permitted to log in to a lower-ranked network device, but a lower-ranked network device is not permitted to log in to a higher-ranked network device, and each network device is configured to be capable of giving rights to view and edit setting information thereon to a selected one of other network devices to thereby establish a parent-child relationship between the network devices.

10. A non-volatile computer-readable storage medium that stores a computer-executable control program for causing a computer to execute a method of controlling a network system including a network device and a device controller,
wherein the method comprises causing:
the device controller to:
acquire, from the network device, respective sets of setting information on a plurality of network devices including the network device, wherein the setting information indicates information on settings set to an associated network device;
display a screen for editing the respective sets of setting information on the plurality of network devices, based on the acquired respective sets of setting information; and
receive an editing instruction for editing setting information on at least one of the plurality of network devices via the displayed screen, and
the network device to:
collect the setting information from other network devices than the network device within the network system;
transmit the collected setting information together with setting information on the own network device to the device controller; and
edit the setting information on the own network device according to the received editing instruction or transmit the editing instruction to the other network devices.

11. A non-volatile computer-readable storage medium that stores a computer-executable control program for causing a computer to execute a method of controlling a device controller that is capable of communicating with a network device,
wherein the method comprises causing the device controller to:
acquire, from the network device, respective sets of setting information on a plurality of network devices including the network device, wherein the setting information indicates information on settings set to an associated network device;
display a screen for editing the respective sets of setting information on the plurality of network devices, based on the acquired respective sets of setting information; and
receive an editing instruction for editing setting information on at least one of the plurality of network devices via the displayed screen.

12. A non-volatile computer-readable storage medium that stores a computer-executable control program for causing a computer to execute a method of controlling a network device that is capable of communicating with a device controller,
wherein the method comprises causing the network device to:
collect the setting information from other network devices than the network device within the network system;
transmit the collected setting information together with setting information on the own network device to the device controller; and
edit the setting information on the own network device according to the received editing instruction or transmit the editing instruction to the other network devices.
